(19) United States
(12) Patent Application Publication
(10) Pub. No.: US 2002/0178266 A1
(43) Pub. Date: Nov. 28, 2002

(54) High speed server system

(76) Inventors: Alexander Perez, Houston, TX (US); John Thomas White JR., Houston, TX (US); Mark Alan Carrier, Houston, TX (US)

Correspondence Address: Woodard, Emhardt, Naughton, Moriarty and McNett, Bank One Center/Tower, Suite 3700, 111 Monument Circle, Indianapolis, IN, 46204-5137, US

(21) Appl. No.: 10/134,796

(22) Filed: Apr. 29, 2002

Related U.S. Application Data
(60) Provisional application No. 60/287,212, filed on Apr. 27, 2001.

(51) Int. Cl. G06F 15/16

(52) U.S. Cl. 709/227; 709/246

(57) ABSTRACT

A network computer system and method are disclosed that provides access to a large number of concurrent clients without undesirable processor lag and delays. The system prepares client objects in advance of client access requests and can dynamically create new client objects over a distributed system when needed. Buffering is provided to avoid processor interrupts.

### REFERENCE TO RELATED APPLICATIONS

This application claims priority from a Provisional Application Ser. No. 60/287,212, filed Apr. 27, 2001, which is hereby incorporated by reference.

### BACKGROUND OF THE INVENTION

The present invention relates to network-based computing and, more particularly, to a high speed network-based computer system operating over the internet.

Network-based computer systems have been used for many years by companies in order to connect individual users within a company, often at more than one geographic location, to central processors or servers. The advantages of a network include the ability to consolidate all work on one or more central computers, which provides efficient data backup that is not adversely affected by a hardware failure or “crash” of any individual computer or workstation. The use of network-based software is also an advantage, as users may have access to specialized software for which individual copies for each employee would not be justified. The cost for such software for use on a network may also be less expensive than individual copies, particularly if the number of users permitted to access a given software package at any one time is limited.

Such networks as previously described have traditionally be limited to companies that install or lease dedicated communications links between the network computers and the individual workstations. Access to the network is limited to employees or third parties who had been specifically installed and properly set-up by the network administrator. The number of network users is known and controlled, and the capabilities of the network, e.g., speed and processing ability, is designed knowing those numbers. As new employees or network users are added, the need for additional network capability can be predicted, and the network can be upgraded to accommodate those needs in a planned and organized way.

The advent of network-based computing over the internet brings the advantages of dedicated networks to individual users or subscribers, giving individuals access to specialized, expensive computer software that could not be justified for individual purchase due to infrequency of use or cost. Convenient and reliable backup of data that is stored on the network is also a desirable benefit.

The design and administration of such an internet-based network presents problems, however. The numbers of users or network subscribers may vary in large and unpredictable ways, making network upgrades difficult to plan and implement. Large numbers of users who demand network system resources at the same time results in processing delays and unhappy customers.

Network security is also a concern. It is important to allow only authorized users to have access to the network, and to allow users to have access to only their own data and documents. Providing this security is possible through user authentication and data encryption, but such functions also require the use of network system resources and may also increase processing time, which appears to the user as a slowing of the network operation.

### SUMMARY OF THE INVENTION

It is therefore an object of the present invention to provide a high-speed internet-based network system that rapidly adjusts for changes in the number of concurrent users.

It is a further object of the invention to provide an internet-based network system that permits rapid encryption and decryption of user data and documents.

It is a further object of the invention to provide an internet-based network system that is easily scalable and distributable in order to accommodate changes in the number of network subscribers.

These and other objects will become apparent from the illustrated drawings and the description of the embodiments.

### BRIEF DESCRIPTION OF THE DRAWINGS

FIG. 1 is a block diagram of the network computer system in accordance with the present invention.

FIG. 2 is a diagram showing the functional layers of the computer system of the present invention.

FIG. 3. is a flow chart illustrating an aspect of the operation of the network computer system of the present invention.

### DESCRIPTION OF THE EMBODIMENTS

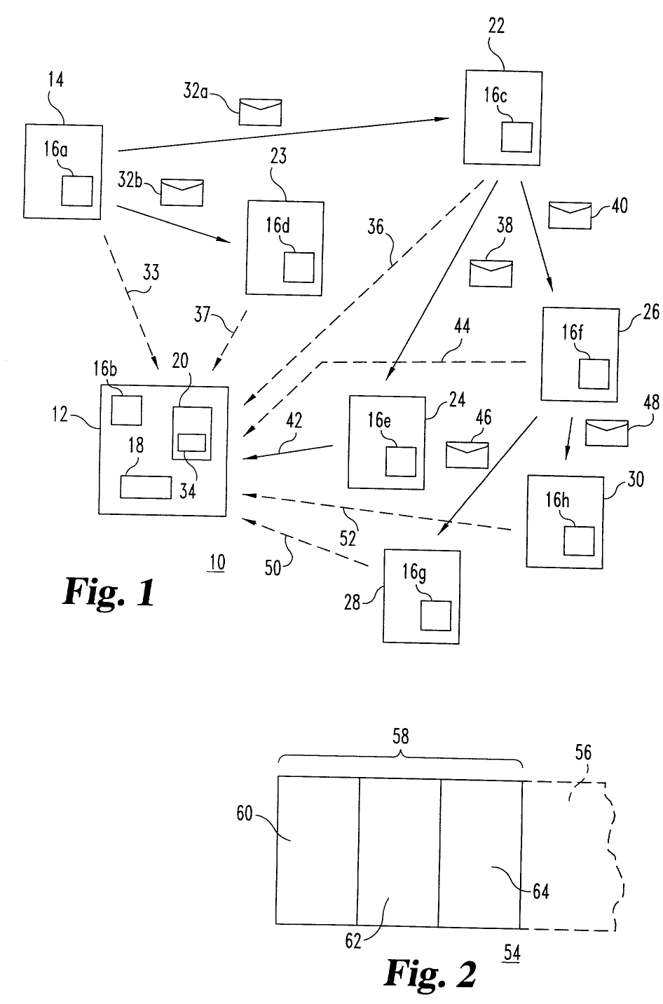

Referring to FIG. 1, there is shown a network computer system 10 that includes a central server 12. Server 12 is of conventional design, but it has been found that a Unisys ES7000 computer provides the desired capabilities needed for efficient operation of the network system. Server 12 is operatively connected with computer 14a, which forms a connection machine or factory with individual users on the network. Computer 14 incorporates security functionality, including firewall 16a. Individual users, represented by individual user computers 18a, 18b, and 18c, may connect to computer 14athrough a variety of methods, but is illustratively shown in FIG. 1 and described herein as being via the internet, designated 19 in FIG. 1. The number of individual users on system 10 at any given time may vary considerably; and may increase or decrease quickly. This variability is shown in FIG. 1 as individual user computer 18n, shown in phantom. System 10 may bring additional connection machines, such as computer 14b (with firewall 16b), shown in phantom, online as needed to service individual users, such as user computer 18n. System 10 therefore provides efficient scalability to add connection computers as needed.

In accordance with an aspect of the present invention, server 12 is able to prepare for client- or user-requested connections before the user computer actually makes the connection request. This is accomplished by creating, or registering, a sufficient number of client or user connection objects 20 with the operating system of server 12 at the time of startup of server 12. The number of client or user connection objects 20 that are registered is determined based on an estimate of the number of users that are expected to request connection, such that the number of available user objects is equal to or exceeds that number of expected users; however, the number of client or user objects 20 that are registered or prepared is dependent upon the available system resources of server 12. The presence of prepared and registered user connection objects 20 allows system 10 to be immediately responsive to a large number of user connection requests that all arrive at the same time. As users are connected and consume the connection objects 20, more objects are created and registered to make sure sufficient numbers of connection objects are available.

To improve efficiency of system resources, a user connection is only maintained for the length of time necessary to fulfill the request of the user. For example, if a file is to be transferred, the file length is given at the beginning of the communication session, so that when it is determined that a block of data has been transferred equal to the predetermined file size, the file is deemed to have been transferred, and the connection is consequently severed. By the above-described process of maintaining prepared client or user objects, which permits rapid reconnections with users when further activity is desired, terminating user communications does not adversely affect the network's ability to respond timely to a particular user's requests. Server 12 may also act to disconnect any user if there is no request activity for a predetermined period of time.

System 10, which utilizes TCP communications protocols with users, transfers information as packet streams. In this embodiment, information such as data files shares the same packet stream with user requests, so that server 12, via connection computers 14a and 14b, can continue a conversation with a client as long as there are client or user requests to process and/or responses to send. The above system also permits dynamic data compression and encryption by way of distributing the creation of compression and encryption object across as many computers or processors within the network as necessary, so that the operation of the operating system of server 12 is not adversely impacted or slowed. By this process, server 12 may delegate encryption/decryption, compression/decompression, and other functions to other computers or processors, such as computer 22, that are located within system 10 in order to speed processing of user requests and to avoid overloading the processor resources of server 12.

As illustrated in FIG. 2, network computer system 10 is composed of four functional layers. The first layer 21 is the communications layer that is responsible for the TCP/IP message traffic between network system 10 and the user computers 18a, 18b . . . 18n. This layer 21, also referred to as the stateless request handler, supports multiple TCP servers running concurrently, and is responsible for utilizing additional TCP servers located within the network as necessary during operation to support the users requesting connections with sever 12. The communications layer can simultaneously and seamlessly support user communications via HTTP applications. The communications layer also is responsible for detecting and resolving network intrusion and service disruption attacks. It also utilizes asynchronous transaction logging of user attributes, such as user IP addresses for the communications layer, for example. System 10 utilizes a separate thread for this transaction logging function, which runs in parallel with the main executable user-related transactions. The system posts messages to the logging thread which then performs the requested logging function concurrently with other transaction functions.

The second functional layer 23 is referred to as the encryption and compression layer. Multiple encryption and compression algorithms are supported concurrently, including for example, 56- and 128-bit RSA cryptography. Encryption and compression objects are created and managed dynamically based on the number of connected users to provide fast encryption and compression of data as needed. This layer also utilizes the logging thread previously described to permit asynchronous transaction logging of encryption and compression attributes, such as user-identified encryption algorithms.

The third functional layer 25 is the broker service or transaction routing layer. This layer is responsible for identifying the type of user transaction being requested, and routing that transaction to the appropriate business objects 27. The business objects 27 relate to the particular type of transaction, such as, for example, file services, email services or services related to the user's personal information manager. In accordance with an aspect of the present invention, the transaction routing layer routs the requested transaction to the appropriate business object, and can accommodate the addition of new business objects which add new or improved services to the network. As an example, a new business object for a new service, e.g., videoconferencing, may be added, without disrupting the operation of the network. The transaction routing layer 25 continues to identify the transaction and routs it to the appropriate business object 27. The transaction routing layer 25 also utilizes the logging thread for asynchronous transaction logging of command types, e.g., is a file involved in the transaction request. The logging thread also logs the length of time that occurs for information to pass between functional layer, in order to gauge the efficiency of the network.

The fourth layer 29 is the data layer. The data layer is responsible for providing data services to fulfill user requests via business objects 27. This layer illustratively uses a Microsoft SQL Server data engine which informs the appropriate functional layer of the requested file location within the network file storage. For example, the file location path is provided to the encryption layer to permit encryption of the file. In the embodiment, a copy of the original file is made and encrypted. Original stored files are not modified. The file location path is then provided to the user who requested it.

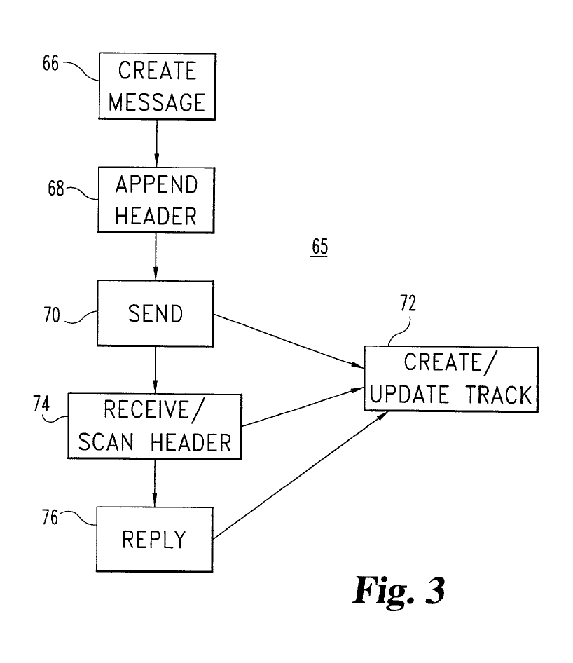

FIG. 3 illustrates the processing steps that occur within the functional layers of network computer system 10. Queuing is used to pass information between layers. As can be seen in FIG. 3, the stateless request handler (SRH) 21, or communications layer, receives a transaction request from a remote user computer 18a. For purposes of this example, the remote user 18a has requested a file that has been stored by network computer system 10. SRH 21 passes this request to the compression layer request queue 26 which performs the step 28 of acquiring any necessary decompression and decryption objects. New objects are created if needed. Decryption and decompression of any requests or data is then performed at step 30. In the example being described, the request is decrypted and decompressed if necessary and forwarded to transaction routing layer input queue 32. From queue 32, the request is passed to the broker service or transaction routing layer 25, which identifies the type of transaction requested and transfers that request to the appropriate one of the business objects 27. The designated business object causes the data layer 29 to request any necessary encryption and/or compression objects that are required to encrypt and/or compress the requested file. The file location path is then given to the communications layer, which then locates and transfers the file to the user who requested it.

While the present invention has been illustrated in the drawing and described in detail in the foregoing description, it is understood that such illustration and description are illustrative in nature and are not to be considered restrictive, it being understood that only the preferred embodiments have been shown and described and that all changes and modifications that would be apparent or would occur to one skilled in the art are to be protected.

What is claimed is:

1. A network computer system comprising:
a first server providing access to a plurality of clients;
a second server controlled by said first server;
a plurality of client objects controlled by said first server and associated with said first and said second servers; and
distribution means operatively connecting said first and second servers, said distribution means permitting said first server to control the distribution of said client objects between said first and second servers in response to said access by said clients.

2. The network computer system described in claim 1, wherein said plurality of client objects is equal to or greater in number than said plurality of clients.

3. The network computer system described in claim 1, wherein said plurality of clients access said first server via the internet.

4. The network computer system described in claim 1, further comprising a plurality of encryption objects controlled by said first server and associated with said first and second servers.

5. The network computer system described in claim 1, further comprising a plurality of compression objects controlled by said first server and associated with said first and second servers.

6. In a network computer system, a method for providing access to a plurality of clients, comprising the steps of:
providing a plurality of client access objects under control of a first server;
providing means for distributing said client access objects between said first server and at least a second server in response to the number of said clients attempting to access said first server;
providing a communications connection between each of said clients and said client access objects; and
severing said communications connection in response to a predetermined period of inactivity of each of said clients.
